(19) United States
(12) Patent Application Publication
(10) Pub. No.: US 2023/0329199 A1
(43) Pub. Date: Oct. 19, 2023

(54) APPARATUS FOR CONNECTING AIR CIRCULATION SYSTEMS IN A CONTAINER HOLDING FISH AND THE LIKE

(71) Applicant: Christopher Michael Hegg, Corpus Christi, TX (US)

(72) Inventor: Christopher Michael Hegg, Corpus Christi, TX (US)

(21) Appl. No.: 18/073,339

(22) Filed: Dec. 1, 2022

Related U.S. Application Data
(60) Provisional application No. 63/285,266, filed on Dec. 2, 2021.

(51) Int. Cl. A01K 63/04; A01K 63/02

(52) U.S. Cl. CPC A01K 63/042; A01K 63/02

(57) ABSTRACT

An apparatus for connecting air circulation systems in a container holding fish and the like is disclosed. The apparatus includes an elongated member. The elongated member includes a threaded portion. The threaded portion connects to a wall of a container. The apparatus encompasses a flange extending from the elongated member. The elongated member includes at least two chambers or ports for connecting air circulation systems. The second chamber connects to a bubbler tube for drawing positive airflow from an air pump into the container. The first chamber connects to a suction tube and pushes out the positive airflow out of the container to ensure that no pressure is retained inside of the container.

The present application claims the benefit of U.S. Provisional Application No. 63/285,266, filed Dec. 2, 2021; all of which is incorporated herein by reference.

### FIELD OF INVENTION

The present subject matter generally relates to accessories for use in a container. More specifically, the present subject matter relates to an apparatus such as a plug connector for connecting air circulation systems in a container or tank holding fish or other aquatic species in water to keep them fresh after catching.

### BACKGROUND OF INVENTION

It is known that containers are used for keeping food and beverages cold for a longer period of time. The containers come in different shapes and are made of different material. In one example, the containers are made of soft material such as a high-density fabric (e.g., special type of foam and nylon webbing) that is waterproof and resistant to mildew, punctures, and UV rays. In another example, the containers are made of hard material such as a metal or hard plastic. The containers include insulated panels that are capable of keeping ice for several days. The containers are preferred as they are portable and easy to transport.

Further, the containers are also used for keeping fish in water to keep them fresh or keeping fish cold after catching. The containers preserve the fish for cooking, while the fishers are not able to refrigerate/freeze/filet or otherwise prepare them as food. The containers used for holding fish are often called as “tanks”, “fish tanks”, “camping coolers” “fishing coolers” and the like. Typical containers do not have a mechanism to supply required air inside them to preserve the fish for a long time. As a result, if the temperature increases or if the fish is kept longer in the containers, then the fish may not stay fresh.

Therefore, there is a need in the art to provide an apparatus such as a plug connector for connecting air circulation systems in a container or tank for supplying air into the container holding fish and the like, the apparatus that allows to preserve the fish for a longer time.

### SUMMARY

It is an object of the present subject matter to provide a unique apparatus or plug connector and that avoids the drawbacks of known fishing coolers.

It is another object of the present subject matter to provide an apparatus for connecting multiple air circulation systems in a container or fish tank or fishing cooler holding fish or other aquatic species.

To achieve one or more objects, the present subject matter presents an apparatus for connecting air circulation systems in a container or tank holding fish or other aquatic species in water to keep them fresh after catching. The apparatus includes an elongated member. The elongated member includes a threaded portion. The threaded portion helps to connect the apparatus to a wall of the container, for example. The apparatus encompasses a flange with a gasket. The flange extends from the elongated member and restricts/stops the apparatus from falling off.

The elongated member includes two chambers or ports i.e., a first chamber and a second chamber. The first chamber and the second chamber extend from one end to another end of the elongated member. In one exemplary implementation, the second chamber connects to an oxygen tube/bubbler tube, air stone or bubbler for drawing positive airflow into the container. The first chamber connects to a suction tube and pushes out the positive airflow out of the container to ensure that no pressure is retained inside of the container.

In one advantageous feature of the present subject matter, the apparatus helps to connect/draw two or more air circulation systems (air inlet and air outlet) to a container holding fish. The apparatus provides air into the container and preserves them for longer. The apparatus helps to connect one or more the air circulation systems without affecting the functionality of the container.

In another advantageous feature of the present subject matter, the apparatus can be manufactured using three-dimensional (3D) printing or additive manufacturing process. The 3D printing reduces the number of parts required to manufacture the apparatus.

Features and advantages of the subject matter hereof will become more apparent in light of the following detailed description of selected embodiments, as illustrated in the accompanying FIGUREs. As will be realised, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

Further features and advantages of the present subject matter will become apparent from the following detailed description, taken in combination with the appended drawings, in which:

FIGS. 1A and 1B illustrate an environment in which an apparatus connects to a container, in accordance with one exemplary embodiment of the present subject matter; and

FIGS. 2, 3 and 4 illustrate a front view, a top perspective view, and a bottom perspective view, respectively of the apparatus, in accordance with one embodiment of the present subject matter.

It will be noted that throughout the appended drawings, like features are identified by like reference numerals.

### DETAILED DESCRIPTION OF THE EMBODIMENTS

Before the present features and working principle of an apparatus is described, it is to be understood that this subject matter is not limited to the particular device as described, since it may vary within the specification indicated. Various features of an apparatus might be provided by introducing variations within the components/subcomponents disclosed herein. It is also to be understood that the terminology used in the description is for the purpose of describing the particular versions or embodiments only, and is not intended to limit the scope of the present subject matter, which will be limited only by the appended claims. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It should be understood that the present subject matter describes an apparatus for connecting air or water circulation systems in a container holding fish or other aquatic species in water to keep them fresh after catching. The apparatus includes an elongated member. The elongated member includes a threaded portion. The apparatus encompasses a flange extending from the elongated member. The elongated member includes two chambers or ports for connecting air circulation systems. The second chamber connects to a bubbler tube for drawing positive airflow from an air pump into the container. The first chamber connects to a suction tube and pushes out the positive airflow out of the container to ensure that no pressure is retained inside of the container.

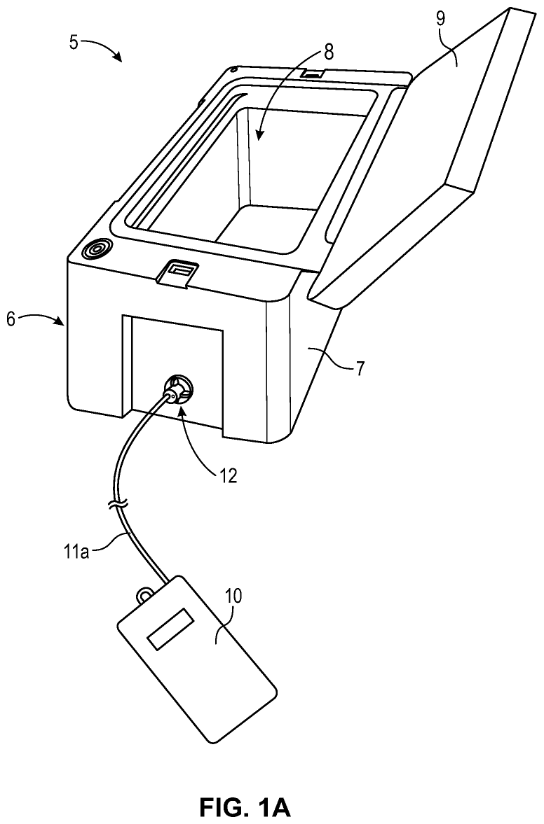

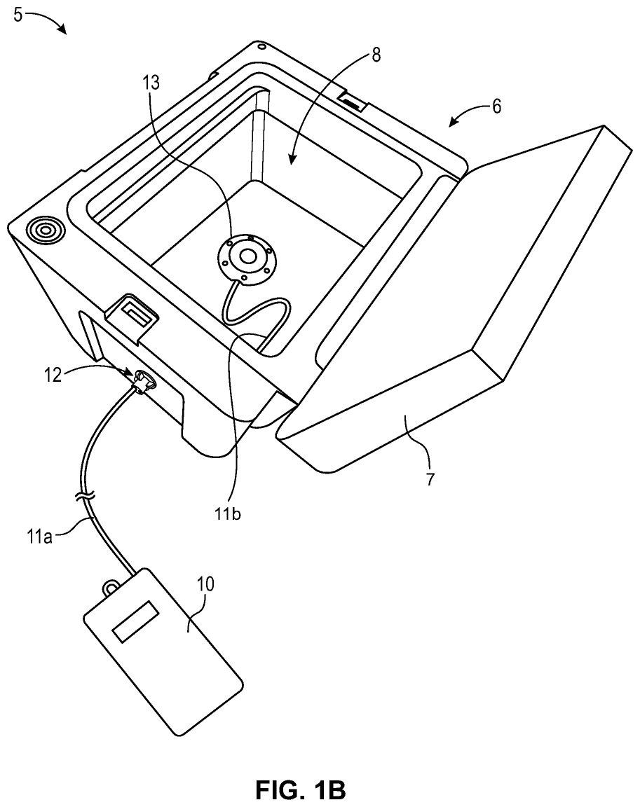

Various features and embodiments of an apparatus for connecting air or water circulation systems in a container or fish tank or fishing cooler holding fish and other aquatic species are explained in conjunction with the description of FIGS. 1-4.

FIGS. 1A and 1B show an environment 5 in which apparatus 12 connects to container 6 holding fish and other aquatic species, in accordance with one exemplary embodiment of the present subject matter. Container 6 includes box, fish tank, camping cooler, fishing cooler, aquarium, and the like. Container 6 comes in a variety shapes and sizes. Container 6 is used for storing water or ice depending on the need. Container 6 holds fish or other aquatic species in water or ice to keep them fresh after catching.

As can be seen from FIG. 1A, container 6 includes walls 7 forming an interior 8 for storing water. Container 6 encompasses lid 9 hingedly connected at one side of wall 7. In accordance with one embodiment of the present subject matter, apparatus 12 connects to container 6 at its wall 7, e.g., at a drain hole, for example. Apparatus 12 connects to an air pump 10 such as Bubble Box™ placed at the outside of container 6. In one example, apparatus 12 connects to air pump 10 via first tube 11a having an aerator tube (not shown). Further, apparatus 12 encompasses second tube 11b. Second tube 11b connects to apparatus 12 and extends in interior 8 of container 6. Second tube 11b connects to bubbler member 13 placed at the bottom of container 6, as shown in FIG. 1B. In one example, first tube 11a includes a bubbler tube and second tube 11b includes an air stone tube. Further, bubbler member 13 includes an air stone bubble disc, as shown in FIG. 1B. However, it is possible to provide bubbler member 13 in any shape or configuration depending on the need.

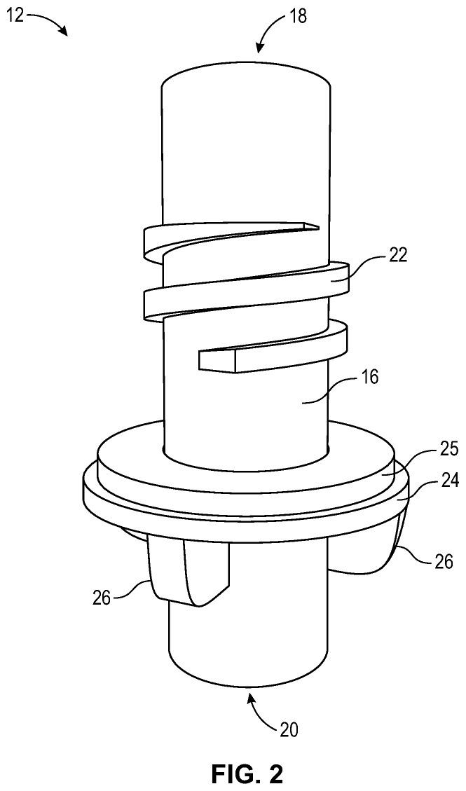

FIGS. 2, 3 and 4 show a front view, a top perspective view, and a bottom perspective view, respectively of apparatus 12, in accordance with one embodiment of the present subject matter. Apparatus 12 includes elongated member or elongated tube 16. Elongated member 16 is made of a material such as metal, plastic, or any other suitable material. Elongated member 16 presents first end 18 and second end 20. First end 18 indicates a top end of elongated member 16 and second end 20 indicates a bottom end of elongated member 16.

Elongated member 16 includes a threaded portion 22. Threaded portion 22 positions at about the center section of elongated member 16. Threaded portion 22 has a suitable pitch and helps to receive the air circulation systems (not shown). Further, apparatus 12 includes flange 24. Flange 24 surrounds and extends from elongated member 16. As can be seen from FIG. 2, flange 24 positions off the center of elongated member 16 and proximity to second end 20. However, it is possible to position flange 24 at desired position/length over elongated member 16 depending on the need. In one example, flange 24 includes a rubber gasket 25 facing first end 18 to prevent leakage from container 6. In one example, flange 24 includes support members 26. Support members 26 position underneath flange 24 at second end 20. Support members 26 extend from elongated member 16 and connect underneath flange 24 in order to provide desired strength for flange 24.

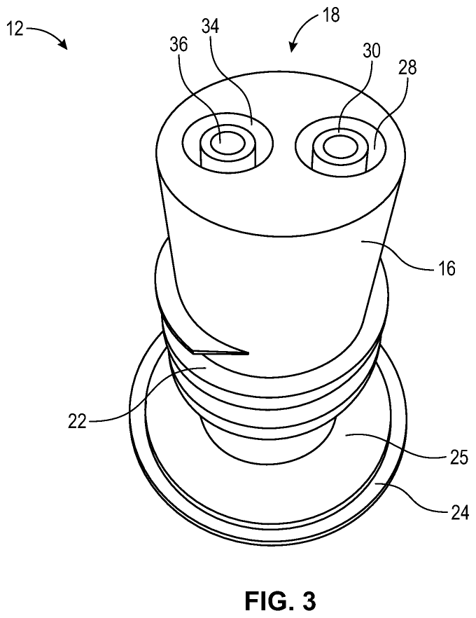

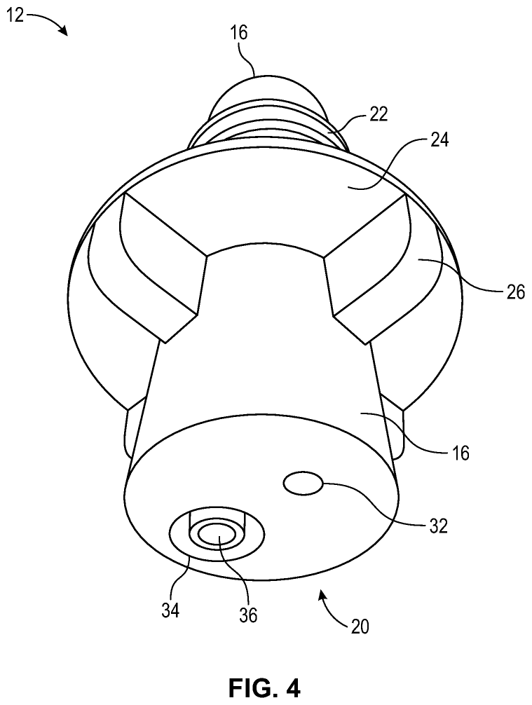

At first end 18, elongated member 16 encompasses first port or first chamber 28 having first hole 30. First hole 30 extends from first end 18 (FIG. 3) until second end 20 forming exhaust port or exit port 32 (FIG. 4). It should be understood that first hole 30 is a single conduit that extends and ends as exit port 32 at second end 20. Further, elongated member 16 encompasses second port or second chamber 34 having second hole 36. Here, second port 34 and second hole 36 extend from first end 18 (FIG. 3) until second end 20 (FIG. 4).

In one example, apparatus 12 connects at the drain hole positioned at side wall 7 of container 6, as shown in FIG. 1A. Here, second end 20 faces the outside of wall 7 and first end 18 faces interior 8 of container 6. Threaded portion 22 of elongated member 16 inserts and connects to the drain hole. Gasket 25 ensures that there is no gap between elongated member 16 and wall 7 of container 6 and prevents leakage of water from container 6 when apparatus 12 is connected to container 6.

In accordance with the present subject matter, first chamber 28 and second chamber 34 help to connect air circulation systems e.g., air pump 10 and a suction tube (not shown) to container 6. For example, second chamber 34 at second end 20 receives first tube 11a from air pump 10. As specified above, second hole 36 runs from second end 20 to first end 18. At first end 18, second tube 11b connects to second chamber 34. Second tube 11b extends and connects to bubbler member 13 placed at the bottom of container 6.

In use, water is poured in interior 8 of container 6 and live fish and other aquatic species are placed in the water. Subsequently, air pump 10 is connected to apparatus 12 and powered ON. Here, air pump 10 operates and pushes air into bubbler member 13 via first tube 11a, second hole 36 and second tube 11b. In other words, second hole 36 draws positive airflow into bubbler member 13 from air pump 10 via first tube 11a and second tube 11b. Subsequently, bubbler member 13 defuses the air into container 6 storing water. A person skilled in the art understands that bubbler member 13 produces oxygen bubbles and releases into the water to improve air circulation in container 6 and helps to keep the water fresh for a better environment for fish and other aquatic species.

As container 6 is airtight, the positive airflow received needs to be sent out to avoid pressurised environment inside container 6. In the present subject matter, first chamber 28 at first end 18 receives a suction tube (not shown) connected to a suction cup (not shown) placed at the top of container 6. Suction cup draws air from container 6 (i.e., air above the water) and transfers to first hole 30 via the suction tube. Here, first hole 30 draws the air and pushes out through exhaust port 32 into the environment outside container 6. This ensures the positive airflow that goes into container 6 is pushed out of container 6 making sure that there is no pressure is retained inside of container 6.

Although the present disclosure provides two chambers in the apparatus, it is possible to provide more than two chambers in different configurations to connect air circulation systems. Alternatively, the chambers can be used to connect water circulation systems depending on the need. The presently disclosed apparatus or plug connector helps to connect multiple air circulation systems (air inlet or air outlet) to a container holding fish or other aquatic species. The apparatus supplies the oxygen to the fish stored in the container and ensures they remain fresh for a longer duration. Further, the apparatus draws out the positive airflow accumulated in the container to ensure there is no pressure retained in the container. The presently disclosed apparatus can be used with any coolers such as Yeti™ coolers, Igloo™ coolers, for example.

In one example, the presently disclosed apparatus is manufactured using a three-dimensional (3D) printing or additive manufacturing process. The 3D printing process lowers the manufacturing cost of the apparatus.

A person skilled in the art appreciates that the apparatus may come in a variety of sizes depending on the need and comfort of the user. Further, different materials in addition to or instead of materials described herein may also be used and such implementations may be construed to be within the scope of the present subject matter. Further, many changes in the design and placement of components may take place without deviating from the scope of the presently disclosed apparatus.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the subject matter, it is intended that all matter contained in the above description or shown in the accompanying drawings shall be interpreted as illustrative and not in a limiting sense.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. It is contemplated that additional embodiments are within the spirit and true scope of the disclosed subject matter.

I claim:

1. I claim all of the above subject matter.
